(19) United States
(12) Patent Application Publication
(10) Pub. No.: US 2026/0358801 A1
(43) Pub. Date: Nov. 12, 2026

(54) AUTONOMOUS VEHICLE WITH SENSORS

(71) Applicant: UAVIA, Vitry Sur Seine (FR)

(72) Inventors: Pierre PELE, Vitry Sur Seine (FR); Pierre VILPOUX, Vitry Sur Seine (FR)

(21) Appl. No.: 19/490,773

(22) PCT Filed: Jun. 7, 2024
(86) PCT No.: PCT/IB2024/055617

§ 371 Date: Dec. 5, 2025

(30) Foreign Application Priority Data
Jun. 7, 2023 (FR) FR2305752

(51) Int. Cl. G05D 1/225; G05D 1/226; G05D 1/228; G05D 101/15; G05D 109/25; G08G 5/26; G08G 5/34

(52) U.S. Cl. CPC G05D 1/225; G05D 1/226; G05D 1/228; G08G 5/26; G08G 5/34; G05D 2101/15; G05D 2109/254

(57) ABSTRACT

An autonomous piloted aerial vehicle (E) comprises motorized propulsion means (30, 31), a control unit (P) for the propulsion means to guide the vehicle along a flight path provided by a piloting unit, at least one sensor (C1, C2, C3) capable of delivering data requiring digital processing, the vehicle being equipped with onboard digital processing circuitry (1300), and being connected to at least one remote processing circuitry (2300, 3300) via a wireless communication network (WCC). According to the invention, it comprises:

a distribution circuit (1200) capable of directing data from the sensor(s) to the on-board processing circuitry or to the remote processing circuitry according to at least one criterion among: a type of processing to be performed, a processing capacity of the on-board processing circuitry and the remote processing circuitry, a processing availability of the on-board processing circuitry and the remote processing circuitry, a capacity of the wireless communication network, a wireless communication network availability, a data processing rate instruction,

a circuit (1400) for recombination of data processed by the on-board processing circuitry and the remote processing circuitry, and—a circuit (1700) for interface with the control unit, the latter being configured to take into account the said processed data recombined at a given time and generate instructions for adjusting the behavior of the vehicle.

### SCOPE OF THE INVENTION

The present invention relates generally to autonomous vehicles, for example, aerial drones (or UAVs for “ Unmanned Aerial Vehicles”). Aerial Vehicles (in English), equipped with sensors.

### PRIOR ART

Such devices are becoming increasingly sophisticated, and a significant development in their use in recent years has been in the field of collecting data of extremely diverse natures.

Thus such devices can be equipped with sensors for measuring environmental data (meteorological data such as wind, humidity, temperature, brightness, cloud cover, pollutants, radioactivity, radio frequency signals, to name just a few examples), or image sensors (in the visible or non-visible domains).

Some sensor data do not require any special processing, and are simply formatted for transmission to the ground via an appropriate communication channel.

Other sensor data require significant digital processing. In particular, when several types of data are measured, resynchronization, combination, interpolation, or prediction processes, for example by deep learning, may require significant computing resources in terms of processing power and memory capacity.

Furthermore, it may be desirable to adjust the path of the device according to the measurements taken, and the more complex the processing, the greater the electrical power consumed, and the more difficult it will be to obtain good responsiveness of the device according to the results of the measurement processing.

### SUMMARY OF THE INVENTION

The present invention aims to overcome all or part of these limitations of the prior art.

For this purpose, an autonomous piloted aerial vehicle is proposed, comprising motorized propulsion means, a propulsion means control unit to guide the vehicle to follow a flight trajectory provided by a piloting unit, the vehicle further comprising at least one sensor capable of delivering data requiring digital processing, the vehicle being equipped with on-board digital processing circuitry, and being connected to at least one remote processing circuitry via a wireless communication network, the vehicle being characterized in that it comprises:
a distribution circuit capable of directing data from the sensor(s) to the on-board processing circuitry or to the remote processing circuitry according to at least one criterion among: a type of processing to be performed, a processing capacity of the on-board processing circuitry and the remote processing circuitry, a processing availability of the on-board processing circuitry and the remote processing circuitry, a capacity of the wireless communication network, a availability of the wireless communication network, a data processing rate instruction,
a circuit for recombining data processed by the on-board processing circuitry and the remote processing circuitry, and -an interface circuit with the control unit, the latter being configured to take into account the said processed data recombined at a given time and generate instructions to adjust the behavior of the vehicle.

Certain advantageous but optional aspects of such a device include the following additional features, taken individually or in any combination that a person skilled in the art will understand to be technically compatible with each other:
instructions for adjusting the behavior of the device belong to a group comprising:
   flight adjustment instructions,
   instructions for adjusting the capture using the sensor(s),
   instructions for adjusting the methods of digital processing of data from the sensor or at least one sensor.
said interface circuit is configured to generate a map of the recombined processed data, with a view to dynamically determining the trajectory of the vehicle.
the adjustment instructions include flight adjustment instructions capable of modifying the limits of a sweep of an area with the vehicle, and/or the speed of movement of the vehicle, and/or the accuracy of traversing the swept area.
the data provided by at least one sensor are data characterizing the atmosphere of the area.
the processing to be carried out on the data from at least one sensor includes algorithmic processing.
the algorithmic processing includes at least one of a spectral decomposition processing, a matrix computation processing, a learning-based processing, a graph traversal processing.
at least part of the remote processing circuitry is accessible via a radio network.
at least part of the remote processing circuitry is accessible via a wide area network.
at least one criterion is determined using a processing resource management device.
the processing resource management device is common to all the vehicles.
the processing resource management device implements a management protocol using a signaling channel of the wireless communication network.

### BRIEF DESCRIPTION OF THE DRAWINGS

Non-limiting embodiments of an apparatus according to the present invention are now described in detail with reference to the accompanying drawings, in which:

FIG. 1 is a schematic perspective view of a device according to the invention,

FIG. 2 is a block diagram of the digital architecture of a device according to the invention and of remotely available digital resources,

FIG. 3 is a more detailed block diagram of a particular implementation of the digital architecture of FIG. 2, and

FIG. 4 is a detailed block diagram of a possible implementation of embedded and non-embedded processing resources.

### Detailed description of preferred embodiments

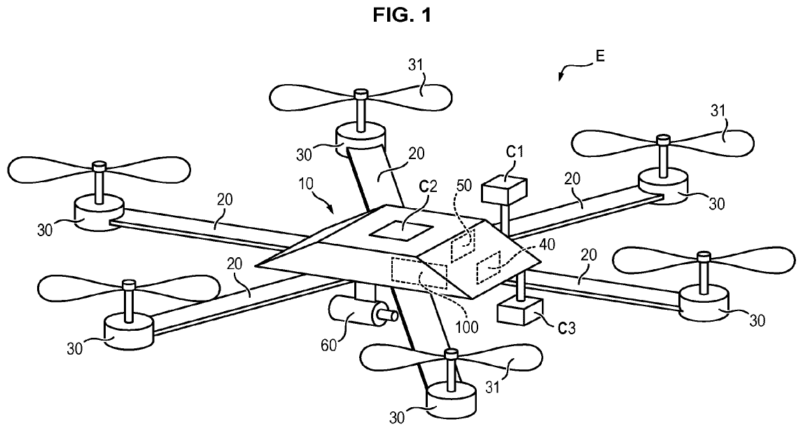

With reference to FIG. 1, an autonomous flying vehicle E or drone, here of the six-rotor type, is shown. It comprises a main body 10 and a set of arms 20 supporting as many rotors 30, each equipped with a propeller 31. Intrinsically, such a vehicle includes an inertial measurement unit 40 capable of delivering kinematic data, and a positioning unit 50, for example, of the GPS standard, capable of delivering universal positioning data. It is also conventionally equipped with one or more cameras 60, the images of which are transmitted to the ground via a suitable communication channel.

The vehicle finally includes one or more electronic boards 100, ensuring, in a manner known per se, the functions of autopilot, wireless communication with a non-onboard digital environment and in particular a ground station, and various onboard computing means with processors, memories, input/output interfaces, etc. The whole is powered by one or more rechargeable batteries not shown.

The drone is equipped with a set of other sensors, here three sensors C1, C2, C3, which will be referred to here as “specialized” sensors depending on the type of application envisaged.

These sensors can be based on extremely diverse technologies, including physical, optical, acoustic, chemical, and deliver data which, after possible formatting, consists of digital data of varying sizes, at rates which can be extremely variable.

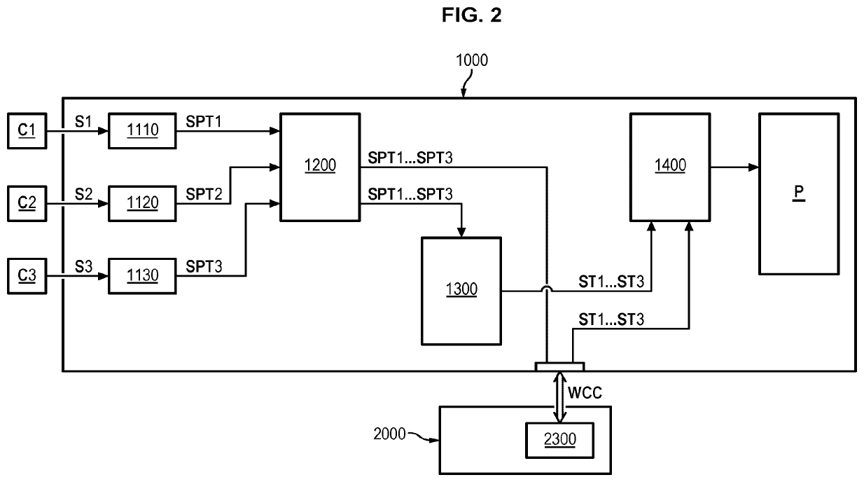

With reference to FIG. 2, sensors C1, C2, C3 deliver signals S1, S2, S3 which can be pre-processed in dedicated circuits or units 1110, 1120, 1130 (or possibly a common circuit). Such pre-processing can consist of various operations chosen in particular from analog-to-digital conversion, normalization, filtering, formatting, etc., depending on the type of sensor and the design of the downstream processing circuits.

More specifically, this preprocessing may include, for example, operations such as formatting into messages, each containing a data field containing the data to be processed from a sensor, sensor identifier information, timestamp information, scheduling data, derived, for example, from the timestamp data, and any other useful data or metadata, such as (i) data provided by other elements such as an inertial measurement unit, other sensors conventionally fitted to the vehicle and not requiring processing, such as temperature sensors or distance sensors, and/or (ii) indicative data of the digital processing capacity required for the data contained in the message. Each unit 1110, 1120, 1130 can also, depending on the type of data received from a sensor, or the type of sensor that generated the data, insert into the message data representing processing instructions to be executed, for example in the form of the address of a subroutine to be executed at the level of a local processing circuit (typically at the edge). computing (in Anglo-Saxon terminology) or a remote processing circuit.

In cases where the data from the different sensors are provided at different rates, interpolation techniques are used, for example, to resynchronize them.

It should be noted that for certain types of sensors, the pre-processing unit is integrated into the sensor.

The digital signals SPT1, SPT2, SPT3 from the output of the preprocessing circuits 1110, 1120, 1130 are received by a distribution circuit 1200.

This 1200 circuit is configured to route the SPT1, SPT2, and SPT3 signals to a digital signal processing resource chosen from a set of digital signal processing resources. The digital processing can be of very diverse types and more or less complex depending on the nature of the processing and the volume of data contained in the SPT1, SPT2, and SPT3 signals. Examples include spectral decompositions, vector or matrix calculations, statistical calculations, etc., in the time and/or space domains. This processing can also implement deep learning mechanisms.

A first resource comprises digital processing means 1300 embedded on board the vehicle (processor(s) and memory). These means may be shared with other embedded processing, or dedicated means.

In cases where the processing to be carried out lends itself to it (for example matrix calculations, spectral decompositions of the FFT type or others, etc.), these embedded processing means advantageously include parallel processors according to “multi-core” architectures.

A second digital processing resource 2300 is located in a remote digital processing environment 2000, with which the vehicle communicates via a WCC wireless transmission channel using a suitable technology. A preferred transmission channel relies on 5G-type cellular technologies.

These remote digital processing means are implemented here in a radio network environment (RAN for “Radio Access Network” in English), one of the important aspects being the throughput and speed of communication via the WCC channel and the processing speed at the level of the remote processing means.

Alternatively or in addition, as will be seen later, these remote digital processing means are implemented in a wide area network environment, for example of the “Cloud” type, with potentially unlimited available resources and processing speeds dependent on the throughput and latency of transmission on the network.

These different processing means are capable of performing different types of processing on the pre-processed signals SPT1, ST2, ST3, distributed by the 1200 circuit, as indicated above.

The signals processed by the remote processing means are returned to the vehicle's circuits via the WCC channel, and all the processed signals ST1, ST2, ST3, whether by the onboard intelligence 1300 or by the remote intelligence 2300, are combined at a reordering or recombination circuit 1400 located in the vehicle. This circuit receives the processed signals in the form of messages, and the role of circuit 1400 is to reorganize the received processed data, particularly in its temporal sequence, to make it usable at the level of a vehicle control unit E, generally designated by P in FIG. 2, for purposes that will be detailed later.

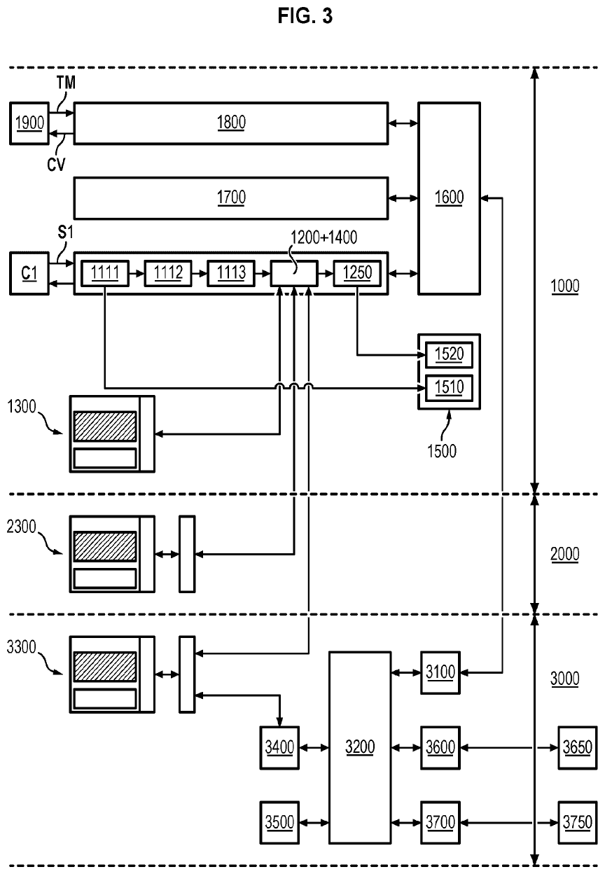

We will now describe, with reference to FIG. 3, an example of a detailed architecture for the implementation of the principles illustrated in FIG. 2.

In the embedded circuitry 100, comprising the embedded digital processing means 1000, a single sensor C1, here a gas sensor, is shown, which generates raw data S1 which are collected by the preprocessing unit 1110 which can be made up of a pipelined processor.

This unit 1110 comprises:
a module 1111 for collecting raw sensor data (interface),
a module 1112 configured to append various types of metadata to the raw data, for example, data included in a group comprising the vehicle's GPS coordinates, its altitude, its speed, wind data (obtained from a specific sensor or from another data source), performing the necessary interpolations in cases where this information is delivered at different rates, and generating messages in the appropriate format and
a module 1113 for queuing messages by attaching a sequence number to them.

These messages are applied to the input of the distribution module 1200 which is responsible for distributing the messages to different digital processing units configured to apply the necessary processing to the sensor data, including the on-board processing unit 1300.

In the present implementation, there is a remote processing unit 2300 deployed at the level of an architecture 2000 accessible by a radio RAN to which the device is connected, with for example a cellular network architecture of the “5G” type, and another remote processing unit 3300 deployed at the level of a wide area network environment 3000 of the “Cloud” type, which may include low latency processing means of the “Edge Network” type.

The distribution unit 1200 performs the distribution according to at least one criterion.

A key criterion is the need to ensure real-time or near-real-time processing of the data produced by the C1 sensor, particularly in cases where this processing is likely to impact the trajectory of the vehicle, as will be detailed later.

In this case, the distribution of data messages to be processed is carried out according to a latency criterion and information on the availability and/or capacity of the processing units 1300, 2300, 3300.

If necessary, in the event that compliance with this criterion is impossible in view of the load of the processing units, the distribution unit may simply reject certain messages, which will not be processed but which may nevertheless be stored for later processing at a later time.

According to another possible criterion, the distribution unit can send the data messages to be processed to the local processing unit 1300, monitor the return from this unit in terms of latency and possibly unprocessed messages, and in the event that the latency becomes greater than a certain threshold, distribute the data messages to be processed between the local unit 1300 and the remote processing units 2300, 3300. The distribution keys can be adjusted dynamically according to the latency measured at the level of the return messages from the processing units.

The above criterion can undergo many variations. For example, the 2300 processing unit located at the radio network level may be preferred for the reliability of its link with the vehicle, or a processing unit located at the “Cloud” level may be preferred for its potentially unlimited processing capacity, although with a greater exposure to latency phenomena.

According to another approach, the circuits embedded in the vehicle can determine a processing capacity per unit of time required, based on a number of criteria.

For example, with a vehicle having a given flight autonomy, having to travel a certain measurement path (for example by scanning parallel lines) and with an imposed measurement step (for example a measurement every X cm), the on-board circuitry (or a remote circuitry) can calculate the speed that the vehicle must have to travel the entire path taking into account its available autonomy (with a safety margin) , which in turn determines the frequency at which the sensor will send data to be processed (the higher the speed must be, the higher the frequency will be and the greater the volume of data to be processed per unit of time).

Based on this calculation, the distribution unit will decide to allocate the necessary resources between the local processing unit 1300 and the remote processing units 2300, 3300 so that this volume of data can be processed.

The sensor data recording unit (log function) is designated by reference 1500. It includes a unit 1510 for storing raw data (here the S1 signals collected at the level of unit 1111) and a unit 1520 for storing processed data.

In delayed time, this data can be transmitted in batches to processing means 2300 and/or 3300 for further processing.

In one embodiment, the metadata insertion module 1112 may also incorporate preprocessing functions which may include:
as mentioned above, an interpolation, which is implemented in the case of several sensors operating at different frequencies, and possibly in a non-synchronous manner (particularly in the case of sensors having their own clock);
statistical calculations (calculations of moving averages, variances or standard deviations, etc.).

The processed data messages issued by the processing means 1300, 2300, 3300 are retrieved at the reordering/recombining unit 1400 (illustrated in FIG. 3 as being located in the same block as unit 1200) and reordered by unit 1400, notably using the sequence numbers contained in the messages. Preferably, unit 1400 is associated with a latency management unit 1250, for example, by rejecting packets received beyond a certain time limit (TTL) and/or packets received out of order (“ jitter ”).

Unit 1400 is connected via unit 1250 on the one hand to the memory 1520 of processed data of recording unit 1500, and on the other hand to a message broker 1600 responsible for routing messages as will now be described.

Agent 1600 redirects messages (or certain messages, depending on their type) to a data analysis module 1700 configured to extract from the sequence of messages processed by units 1300, 2300, and 3300 a number of metrics that can be extremely varied: average noise level, spectral decomposition for detecting gas concentration peaks, sound signatures (in the case of acoustic sensors), spectral signatures in visible or invisible radiation, etc. Module 1700 can also be configured to perform various types of post-processing on the processed and recombined signals. This processing can include filtering, noise reduction, threshold detection, measurement mapping, etc. Alternatively or in addition, such processing can also be performed at the recombination unit 1400.

Agent 1600 also redirects messages received from unit 1250 that may impact the navigation of the vehicle, as well as analysis messages from module 1700, to a navigation module 1800.

This module 1800 comprises a software suite 1100 (software stack) that provides navigation for the vehicle by generating flight commands based either on flight instructions received from a ground station or on the geolocation of the vehicle E and a trajectory to be followed, either stored or dynamically generated according to a number of criteria, including the flight environment. The module 1800 applies the flight instructions CV to a flight controller 1900, which returns telemetry values TM to the module 1800 in a manner known per se.

Here, this module 1800 is also configured to adapt the behavior of the vehicle E based on measurements taken by sensor C1 after processing by means 1300, 2300, 3300 and, where applicable, analysis by module 1700. In a typical implementation, this adaptation includes automatically adjusting the vehicle's trajectory (relative to a setpoint trajectory in the case of autonomous flight). For example, when sensor C1 and the associated processing are designed to perform an environmental measurement (physical, optical, chemical, radioactivity parameters, etc.), the vehicle's trajectory can be modified (reverse course, follow another imposed line, etc.) when the processed sensor data shows that the measured information falls below a certain threshold over a certain range and/or for a certain duration.

It is thus possible to optimize the path of an area (for example, a vertical plane starting from the ground, perpendicular to the wind direction) by limiting overlaps and avoiding traversing regions of the area where the measured parameter is close to zero or insignificant, thereby circumscribing the path of the device to what is necessary. In this case, the device typically includes a wind sensor that allows the orientation of the vertical (or possibly inclined) plane containing the path of the device to be determined by calculation, using the wind vector.

It is also possible, thanks to this function, to optimize the speed of the device and/or the sampling and processing frequency according to certain characteristics of the measurements being processed, in particular in the case where the evolutions of the captured signals become rapid and finer spatial sampling is desired.

In some cases, during a multi-sensor implementation, measurements taken at one sensor may lead to the temporary cessation of further measurements using another sensor, either because these other measurements become unnecessary or less relevant, or to reserve a larger share of the processing capacity for the data from a particular sensor, if necessary by increasing its sampling and processing frequency and/or decreasing its measurement step. This can be carried out either within the 1800 unit or in a specific sensor management unit, not shown.

Furthermore and in a related manner, the sensor data can be applied in whole or in part to an artificial intelligence, hosted in one or more of the processing units 1300, 2300, 3300, intended to adjust the operating conditions of the vehicle and the functioning of the sensors (modification of the trajectory and speed of the vehicle, starting or stopping a certain capture, modification of the capture frequency, choice of the processing unit among the processing units 1300, 2300, 3300 for the data of each of the sensors, with where appropriate specific arbitration rules).

Still with reference to FIG. 3, reference 2000 designates the non-embedded digital processing environment, connected to the vehicle via a radio network architecture and capable of contributing to the processing of pre-processed signals available at the level of the distribution module 1200. The digital processing resources themselves are designated by reference 2300 and will be described in more detail later.

Finally, reference 3000 designates the non-embedded digital processing environment, connected to the vehicle via a “Cloud” type architecture and also capable of contributing to the processing of pre-processed signals available at the level of the distribution module 1200. The digital processing resources themselves are designated by reference 3300 and will be described in more detail later.

Note that the data retrieved by the “Cloud” 3000 environment can be processed in various ways, including:
in real time during flights;
in delayed time;
via an application programming interface (API) to make the data available for other uses.

In particular, in the case where the pre-processed data from a sensor could not be processed in real time, the 3000 environment can execute the processing algorithms in delayed time after downloading the raw data.

Still referring to FIG. 3, the “Cloud” environment 3000 includes a gateway 3100 with the engine E, which is connected to a set of data management services 3200. The data is routed to a sensor data processing service 3400 which makes the connection with the processing means 3300. Conventionally, the services 3200 are also connected to databases 3500, application programming interface (API) gateways 3600 for cooperation with third-party applications 3650, and client gateways 3700 for cooperation with client workstations 3750.

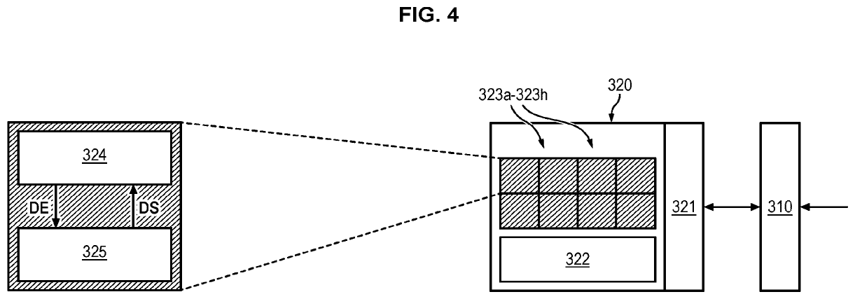

With reference to FIG. 4, an architecture has been illustrated which can be common to the processing means 1300, 2300, 3300.

It comprises a secure proxy 310 and a processing architecture 320 including a computational load manager 321 cooperating with a scheduling unit 322, and a set of processing cores 323a-323h. As illustrated in the left part of FIG. 4, each processing core includes an input/output interface 324 and a processor 325 executing a certain algorithm, receiving the input data DE from the preprocessing and returning the output data DS which will be sent back to the reordering/recombining unit 1400.

In the case where the invention is intended to be implemented with a plurality of vehicles using the local/remote processing architecture as described above, a common device, based on a centralized or distributed architecture, is advantageously provided in relation to the resource allocation mentioned above. This device allows for the management of processing resources available locally at the vehicle level and remotely. This device may have the following tasks, in particular:
the planning of vehicle missions based on available processing resources, availability data being determined by a schedule, response time measurements, etc.
the declaration of availability or need for processing resources, with, for example, an indication of the available or requested processing capacity and the period of availability and the period requested; this data can typically feed into the calendar data used for the planning described above,
the implementation of a time-based resource discovery mechanism using an appropriate protocol, with each accessible processing device capable of receiving a request for this purpose,
the implementation of a time-to-live (TTL) management of packets circulating in the implementation of the architecture of the invention.

Advantageously, this common resource management system is implemented by relying on the signaling channels of the implemented networks.

### Of Course, the Present Invention Can Be Subject to Numerous Variations

and improvements.

In particular, certain types of sensor data to be processed (image sensors or others) can advantageously be compressed and/or encrypted before being sent to a remote processing unit 2300 or 3300. Furthermore, the data from the sensors can be signed in order to certify their authenticity.

The invention has applications in many fields and in particular:
determining the properties of an atmosphere (concentration of pollutants, particles, chemical agents, etc.),
the detection of specific events (fires, crowd movements, road traffic, snowfall, etc.) through image analysis,
verification of an event or measurement determined by external means (sensors from a land site), alert and evacuation system in case of danger to populations, etc.

It applies in particular to the processing of data delivered by a single sensor, in particular a sensor delivering complex signals at high frequency, whether physical, electrical, optical, chemical, etc., or by a plurality of sensors of similar or different types.

1. An autonomous piloted aerial vehicle, comprising motorized propulsion means, a propulsion means control unit to guide the vehicle to follow a flight path provided by a piloting unit, the vehicle further comprising at least one sensor capable of delivering data requiring digital processing, the vehicle being equipped with on-board digital processing circuitry, and being connected to at least one remote processing circuitry, via a wireless communication network, the vehicle being wherein it comprises:
a distribution circuit capable of directing data from the sensor(s) to the on-board processing circuitry or to the remote processing circuitry according to at least one criterion among a type of processing to be performed, a processing capacity of the on-board processing circuitry and the remote processing circuitry, a processing availability of the on-board processing circuitry and the remote processing circuitry, a capacity of the wireless communication network, a wireless communication network availability, a data processing rate instruction,
a circuit for recombination of data processed by the on-board processing circuitry and the remote processing circuitry, and
a circuit for interface with the control unit, the latter being configured to take into account the said processed data recombined at a given time and generate instructions for adjusting the behavior of the vehicle.

2. A vehicle according to claim 1, wherein the instructions for adjusting the behavior of the device are included in a group comprising:
flight adjustment instructions,
instructions for adjusting the capture using the sensor(s),
instructions for adjusting the methods of digital processing of data from the sensor or at least one sensor.

3. A vehicle according to claim 1, wherein said interface circuit is configured to generate a map of the recombined processed data, for the purpose of dynamically determining the trajectory of the device.

4. A vehicle according to claim 2, wherein the adjustment instructions include flight adjustment instructions capable of modifying the limits of a sweep of an area with the device, and/or the speed of movement of the device, and/or the accuracy of traversing the swept area.

5. A vehicle according to claim 1, wherein the data provided by at least one sensor are data characterizing the atmosphere of the area.

6. A vehicle according to claim 1, wherein the processing to be carried out on the data from at least one sensor includes algorithmic processing.

7. A vehicle according to claim 6, wherein the algorithmic processing comprises at least one of a spectral decomposition processing, a matrix calculation processing, a learning-based processing, a graph traversal processing.

8. A vehicle according to claim 1, wherein at least a part (2300) of the remote processing circuitry is accessible via a radio network.

9. A vehicle according to claim 1, wherein at least a part of the remote processing circuitry is accessible via an extended network.

10. A vehicle according to claim 1, wherein at least one criterion is determined using a processing resource management device

11. A set of vehicles according to claim 10, wherein the processing resource management device is common to the set of vehicles.

12. A set of vehicles according to claim 11, wherein the processing resource management device implements a management protocol using a signaling channel of the wireless communication network.
